(19) United States
(12) Patent Application Publication
(10) Pub. No.: US 2002/0022506 A1
(43) Pub. Date: Feb. 21, 2002

(54) DOLL FASHION GAME HAVING COMPUTER GENERATED PRINTED DOLL CLOTHING ARTICLES

(76) Inventor: ANDREW RIFKIN, PALOS VERDES, CA (US)

Correspondence Address: ROY A EKSTRAND, 333 CONTINENTAL BLVD, EL SEGUNDO, CA, 902455012

(21) Appl. No.: 09/383,047

(22) Filed: Aug. 25, 1999

(51) Int. Cl. G06F 17/00

(52) U.S. Cl. 463/1

(57) ABSTRACT

A fashion game is operable upon a conventional computer having a display monitor and a printer. A plurality of garment elements and complete garments are stored within the computer and available for display upon the monitor in combinations dictated by the user controlling the computer. As the garment is fabricated and the elements thereof collected, the user is able to select color and pattern to also be applied to the particular garment. The garment as assembled and completed is displayed upon a doll image on the monitor. An additional software program allows the user to select a particular garment or combination of garment elements to be animated upon a displayed animated doll image which carries forward movements such as walking. A plurality of fabric sheets having a supporting backing are fed through the printer to have the patterns corresponding to the selected garment printed thereon. The printed material sheets are then cut-out along the pattern and assembled upon the doll to form a garment worn by the doll using double-sided attachment tape and hook and loop attachment pads.

### FIELD OF THE INVENTION

This invention relates generally to doll clothing articles and particularly to methods of fabricating such articles.

### BACKGROUND OF THE INVENTION

Many of the most pervasive and long lasting doll playsets to have been created through the years by practitioners in the art involve the process of fabricating clothing articles for various dolls. Such playsets have varied from early relatively simple “cut-out” doll playsets often referred to as “paper dolls” to relatively intricate three-dimensional cloth or fabric doll playsets. Cut-out doll playsets or paper dolls utilized a simple two-dimensional doll form upon which equally simple two-dimensional clothing articles are attached or assembled. Often folding tabs extend at various places along the clothing article periphery to allow the clothing article to partially embrace the two-dimension doll figure. In contrast, miniature fabric doll clothing articles more closely resemble and mimic actual garments of the type worn by people. Such doll toy playsets have enjoyed virtually continuous popularity among a wide age range of child users. Not surprisingly, practitioners in the art have responded to this popularity and have developed a virtually endless variety of doll playsets which involve some use or mimicry of doll clothing articles in combination with some sort of doll or dolls.

For example, U.S. Pat. No. 2,093,207 issued to Munson, Jr. sets forth a DOLL AND COSTUME THEREFOR which utilizes a substantially flat doll figure together with a plurality of interchangeable equally flat clothing articles which may be secured to the doll in an overlying or overlapping fashion.

U.S. Pat. No. 2,331,776 issued to Heggedal sets forth a TOY having a generally flat doll figure and a plurality of adhesively attachable flat clothing articles securable to the doll.

U.S. Pat. No. 2,369,031 issued to Engle sets forth a PAPER DOLL AND METHOD OF MAKING THE SAME utilizing a photographic process for providing a doll having a face which may for example be a photographic reproduction of a child's face.

U.S. Pat. No. 5,178,573 issued to Smith sets forth a MAGNETIC DOLL SET utilizing a ferromagnetic backing panel such as a thin sheet of steel, a representation of a human figure, and a series of clothing and accessory articles which are applied over the human figure. The overlying articles are formed of a magnetic material so as to be drawn to the backing sheet.

U.S. Pat. No. 4,949,286 issued to Ohba sets forth a DRESS DESIGN FORMING APPARATUS for interactively generating and visually displaying deformed free curved surfaces for use in dress designing using a computer-aided display apparatus. The apparatus operates by forming a plane pattern of electronic data representative of a cloth pattern in a two-dimensional plane and thereafter selectively forming the electronic data into a representative three-dimensional shape.

U.S. Pat. No. 5,314,370 issued to Flint sets forth a PROCESS FOR PRODUCING A DOLL utilizing a video camera and color transfer printer means. The process includes the steps of positioning a model in front of a video camera, displaying the face of the model upon a monitor screen, transferring the signal to a printer and printing the resulting image on a wax layer supported on a substrate. The wax layer is pressed and heated against a layer of natural fabric to transfer the wax layer onto the layer of fabric.

U.S. Pat. No. 5,403,224 issued to Gintling sets forth a PHOTOGRAPHIC FACE DOLL WITH REMOVABLE FACE POCKET having a doll fabricated to include an upwardly open pocket in the facial portion thereof. The pocket is configured to receive and maintain a photographic facial inset which is then provided to give the doll a facial region corresponding to the photograph.

U.S. Pat. No. 5,009,626 issued to Katz sets forth HUMAN LIFELIKE DOLLS, MANNEQUINS AND HUMANOIDS AND PET ANIMAL DOLLS AND METHODS OF INDIVIDUALIZING AND PERSONALIZING SAME. A video camera produces an electronic image of a three-dimensional face which is processed by a computer for display upon a monitor. The user then accesses the computer to size and configure the image which is then converted to electronic data which is coupled to a printer. The printer then forms the facial image upon a cloth fabric for use in fabricating a doll or the like having the face thereon. The computer programs includes means for converting the two-dimensional facial image to a three-dimensional pattern on the fabric.

U.S. Pat. No. 5,123,870 issued to Cahill sets forth a DOLL FACE AND HEAD FEATURING FUSIBLE ADHESIVE AND AN APERTURED BATTING MODULE. The apertured batting module is combined with fabric layers to cause portions of the batting material to pass through the apertures and thereby provide a three-dimension contour to the fabric.

U.S. Pat. No. 4,639,235 issued to Ibe sets forth an ATTACHABLE EYE FOR DOLLS having an adhesive attachment utilizing a backing sheet of flexible waterproof fabric.

U.S. Pat. No. 5,380,206 issued to Asprey sets forth a PERSONALIZABLE ANIMATED CHARACTER DISPLAY CLOCK having a plurality of image layers forming a three-dimensional clock face.

In other arts, practitioners have endeavored to improve fabrics and the methods of printing patterns thereon. For example, U.S. Pat. No. 5,410,958 issued to Sharpe sets forth a FABRIC PRINTING PROCESS AND APPARATUS in which the to-be-printed fabric is supported during the printing process by a stabilizing backing sheet or other suitable material. The stabilized fabric sheet may then be printed using conventional printing methods such as screen printing or lithographic printing. Thereafter, the stabilized and printed fabric is then cut and the backing sheet is removed.

British Patent 1,532,036 sets forth IMPROVEMENTS IN AND RELATING TO PRINTING which facilitate printing liquid upon cotton fabrics or the like. Also set forth is an improved liquid jet printing process.

European Patent Application 0553761A1, 0624682A1 and 0652320A1 set forth cloth printing processes utilizing an ink jet printing method.

U.S. Pat. No. 4,791,581 issued to Ohba sets forth a METHOD AND APPARATUS OF FORMING CURVED SURFACES in which a computer-aided display apparatus has defined therein a desired deformation area. At each point within the deformation area, a plurality of vector mathematical quantities are constructed to allow conversion from a two-dimensional image to a three-dimensional curved image.

While the foregoing described prior art devices and methods have often provided improvement in their respective arts, there remains nonetheless a continuing need in the arts relating to doll fashion and clothing games to provide improved more realistic and more interesting doll playsets and methods for playing fashion games.

### SUMMARY OF THE INVENTION

Accordingly, it is a general object of the present invention to provide an improved doll fashion game. It is a more particular object of the present invention to provide an improved doll fashion game which facilitates the use of computer-generated fashion articles in an interactive play pattern. It is a still more particular object of the present invention to provide an improved doll fashion game which encourages the child user to explore a variety of fashion combinations in an amusing and entertaining interactive computer facilitated game play method.

In accordance with the present invention, there is provided a method of playing a fashion game comprising the steps of: forming a display of a doll garment image; observing the doll garment upon a doll image; animating a doll image having the garment thereon; printing a pattern corresponding to the garment upon a fabric sheet; cutting the pattern from the sheet to form a cut-out; and forming the cut-out into a doll garment.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a perspective view of a fashion game constructed in accordance with the present invention;

FIG. 2 sets forth an enlarged display produced in playing the present invention fashion game;

FIGS. 3A and 3B set forth respective front views of alternative doll fashion items fabricated in accordance with the present invention fashion game;

FIG. 4 sets forth a printed pattern of the fashion item set forth in FIG. 3A;

FIG. 5 sets forth a printed pattern of the bodice portion of the fashion item set forth in FIG. 3B;

FIG. 6 sets forth a printed pattern of the skirt front portion of the fashion item shown in FIG. 3B; and

FIG. 7 sets forth a printed pattern of the fashion item shown in FIG. 3B.

### DESCRIPTION OF THE PREFERRED EMBODIMENT

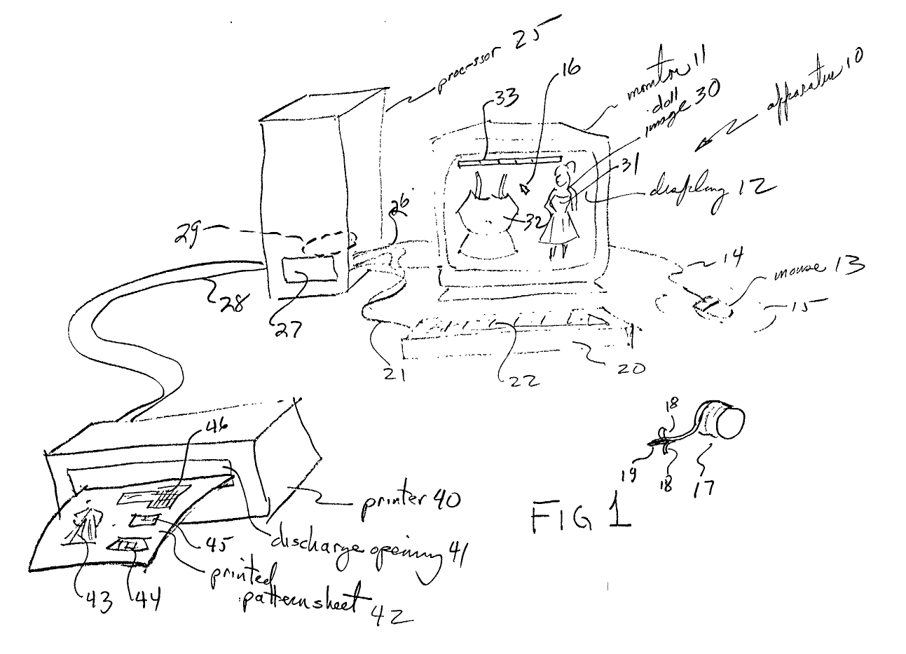

FIG. 1 sets forth a perspective view of apparatus for playing the present invention doll fashion game generally referenced by numeral 10. Apparatus 10 includes a conventional computing system often referred to as a “personal computer”. Thus, apparatus 10 includes a monitor 11 having a display screen 12 such as a cathode ray tube or the like together with a processor unit 25. In further accordance with conventional fabrication techniques, processor 25 includes an input device 27 which, in its preferred form, comprises a conventional CD-ROM drive having conventional apparatus for receiving and supporting as well as reading data from a conventional CD-ROM disk (not shown). Apparatus 10 further includes a coupling cable system 26 operative to couple processor 25 to monitor 11. Apparatus 10 further includes a mouse input device 13 coupled to processor 25 by a cable 14 and resting upon a mousepad 15. A keyboard 20 supports a plurality of depressible keys 22 and is operatively coupled to processor 25 by a cable system 21. In further accordance with the present invention, apparatus 10 includes a printer 40 fabricated in accordance with conventional fabrication techniques which, in its preferred form, comprises a modern printer having graphics capability such as a laser jet printer or bubble jet printer. However, it will be apparent to those skilled in the art that printer 40 may utilize virtually any printing technology in fulfilling the needs of the present invention system. Printer 40 includes a discharge opening 41 through which printed documents are discharged. In accordance with the present invention, printer 40 is shown outputting a printed pattern sheet 42 having a plurality of printed image elements 43 through 46 formed thereon.

In operating the present invention fashion game, monitor 11 is shown displaying a plurality of image elements upon display 12 such as doll image 30, a fashion dress item 31, a second enlarged view of dress 31 indicated as image 32, and a movable cursor 16. Also display on monitor 11 is a selection pad 33 having a plurality of selection areas therein. It will be understood that in accordance with conventional fabrication techniques, mouse 13 is manipulated to move cursor 16 upon display 12 and provide user input capability for selection and movement of images upon the display.

In operation, the present invention provides a set of game rules and game information which is preferably stored upon a convenient apparatus such as a CD-ROM disk 29 shown in dashed-line representation. In accordance with the present invention, the stored instruction set and data upon disk 29 is read by processor 25 using conventional operating techniques to provide the present invention game play.

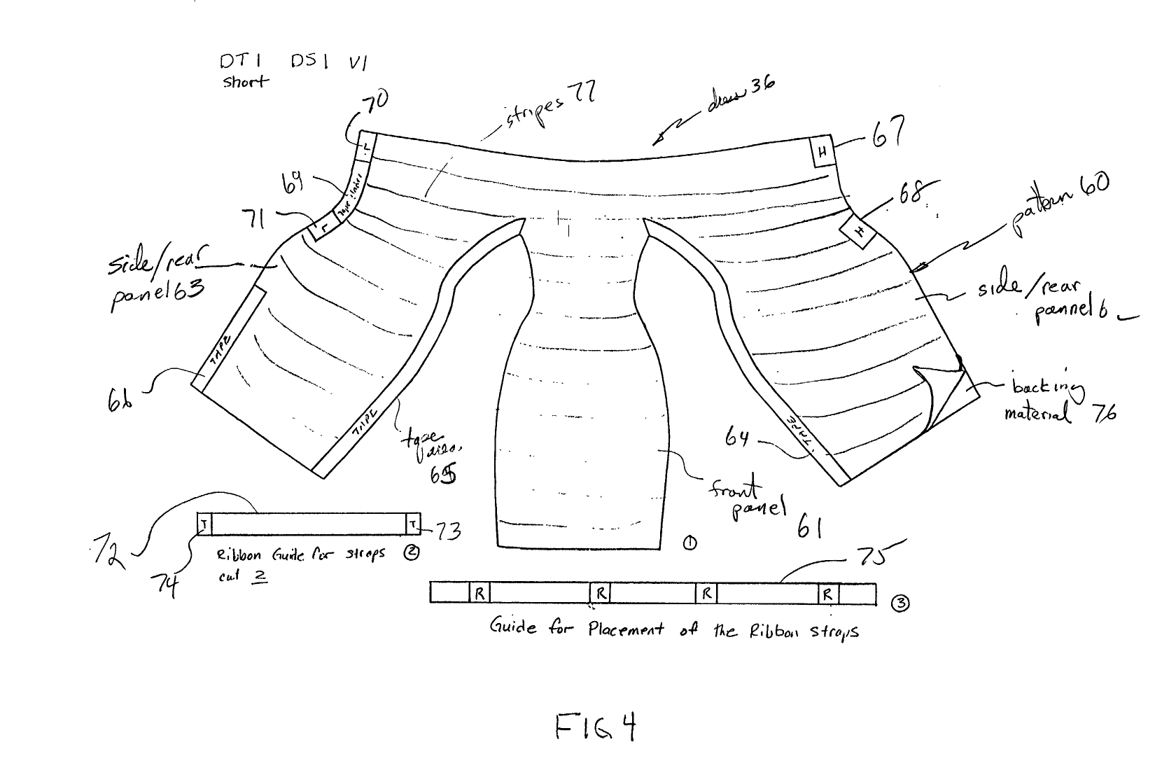

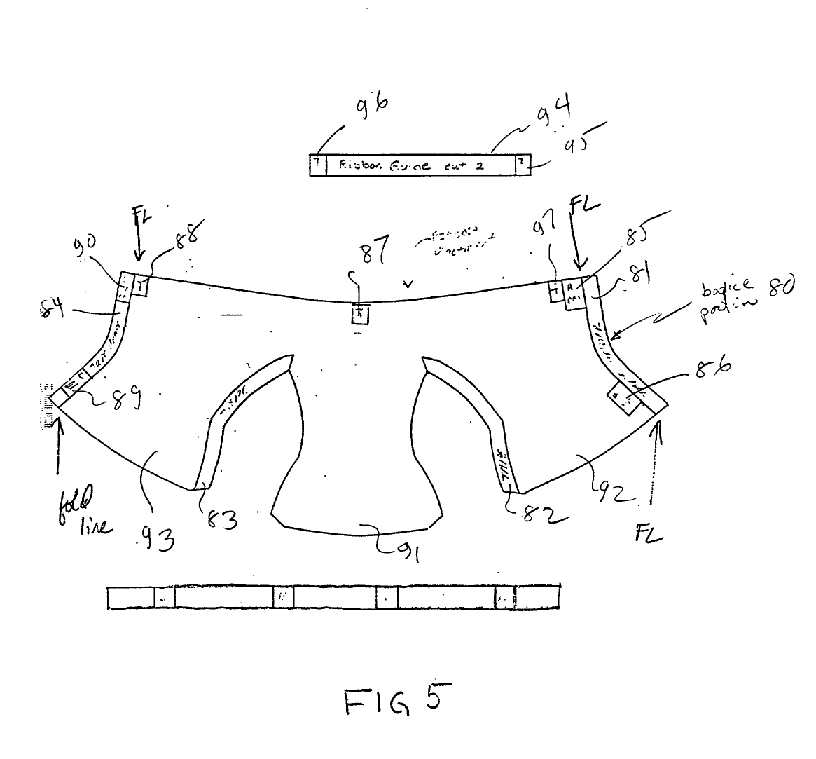

In the anticipated game play of the present invention the user is presented with a succession of image display choices corresponding to various garments or fashion items which may be selected by manipulated mouse 13 to move cursor 16 in an interactive fashion with display 12. Thus, for example, in the configuration shown in FIG. 1, the user has selected garment 31 which is in accordance with the present invention game play displayed upon doll image 30 as though the doll were wearing the particular garment. In further accordance with the present invention, the user is then able to interchange other garments upon doll 30 by manipulating cursor 16 and selecting alternative garments. For example, an abbreviated form of dress 31 shown as image 32 may be selected and placed upon doll image 30 to display the garment. By way of further variation, other elements such as color or pattern may be selected using display bar 33 to provide augmentation or variation of garment 32 which is then correspondingly worn by doll image 30. For example, the user may, through manipulation of cursor 16 using mouse 13, select various colors for garment 32. Alternatively, different patterns may be superimposed upon the selected color or colors. When the user is content with the garment as viewed on doll image 30, the user then executes a print command causing printer 40 to produce a printed pattern sheet such as pattern sheet 42. In further accordance with the present invention, the pattern elements required to form the selected garment such as garment 31 in the desired colors and patterns is printed upon one or more of pattern sheets 42 by printer 40. FIGS. 4 through 7 set forth below show examples of printed patterns of the type which result from practicing the present invention fashion game.

In the preferred fabrication of the present invention, printing pattern sheet 42 comprises a combination of a selected cloth fabric or the like having a somewhat stiffer support lamination or backing sheet secured thereto. Such printing of patterns upon cloth supported by stiffening laminations is well known in the art and set forth for example in the above-described prior art. Of importance to the present invention is to provide cloth sheets having sufficient stiffness to be capable of transport through an otherwise conventional printer 40. It will be recognized that alternative measures for stiffening the pattern sheet other than bonding to support laminations may be utilized without departing from the spirit and scope of the present invention.

In further accordance with an important aspect of the present invention, the operation of processor 25 utilizing the stored game play instructions set within CD-ROM 29 allows processor 25 to color and emboss the selected patterns upon the various image objects. By way of further alternative, however, the user may elect to omit color from the pattern printing and utilize conventional coloring items such as markers or the like in hand coloring the printed pattern sheet for further creativity.

Once the pattern has been printed upon one or more of the pattern sheets in the manner described above, the user then is able to cut out the particular pattern elements and thereafter remove the backing sheet portions therefrom in a simple peel-off operation. The resulting fabric pattern elements are then assembled using conventional attachment apparatus in the manner described below in FIGS. 4 through 7. It has been found particularly advantageous for younger children to utilize attachment apparatus which is essentially formed of elongated strips of double-sided adhesive tape material such as that shown as double-side tape roll 17 in FIG. 1. For purpose of illustration, tape 17 is shown having protective laminations 18 peeled from the end portion exposing a double-sided adhesive strip 19. It will be apparent from the descriptions which follow that the double-side tape is cut in appropriately sized elements for use in fabricating the doll fashion garments using the printed pattern elements.

FIG. 2 sets forth an enlarged view of display 12 of monitor 11. In accordance with a further operation of the present invention game, display 12 shows an enlarged animated doll FIG. 35 together with various background scene elements such as a fashion runway 39 having runway lights 38 together with a plurality of simulated audience faces 37. Thus, background elements 37 through 39 place animated doll 35 in a desired scene such as a fashion show. It will be apparent to those skilled in the art however that alternative background scenes may be selected for displaying doll 35 without departing from the spirit and scope of the present invention. In accordance with a further aspect of the present invention game play, doll 35 is displayed wearing a garment 36 and is animated in accordance with conventional computer animation techniques. In further accordance with the use of conventional computer animation techniques, garment 36 is also animated to move in correspondence with the movement of animated doll 35. Thus, the child user in accordance with the present invention game play is able to select a garment as described above which may be designed from selected elements and impart a desired color or pattern thereto. The child may then utilize mouse 13 (seen in FIG. 1) to switch the image upon display 12 to the animated FIG. 35 as shown in FIG. 2 to observe a predetermined sequence of animated movements by doll 35 wearing the garment which the child user has previously designed. Thus, for example, doll 35 may be animated to undergo repeated cycles of a fashion walk similar to that which fashion models employ back and forth upon walkway 39. This added aspect of the present invention fashion game imparts substantial interest and amusement value as the child user is able to observe the selected garment from all sides and angles as the animated figure moves about while wearing the selected garment. While the process of viewing the selected garment upon animated FIG. 35 may be employed virtually any time in the game play, it is anticipated that the child user may well prefer to observe the animated display prior to printing the garment as part of the design process.

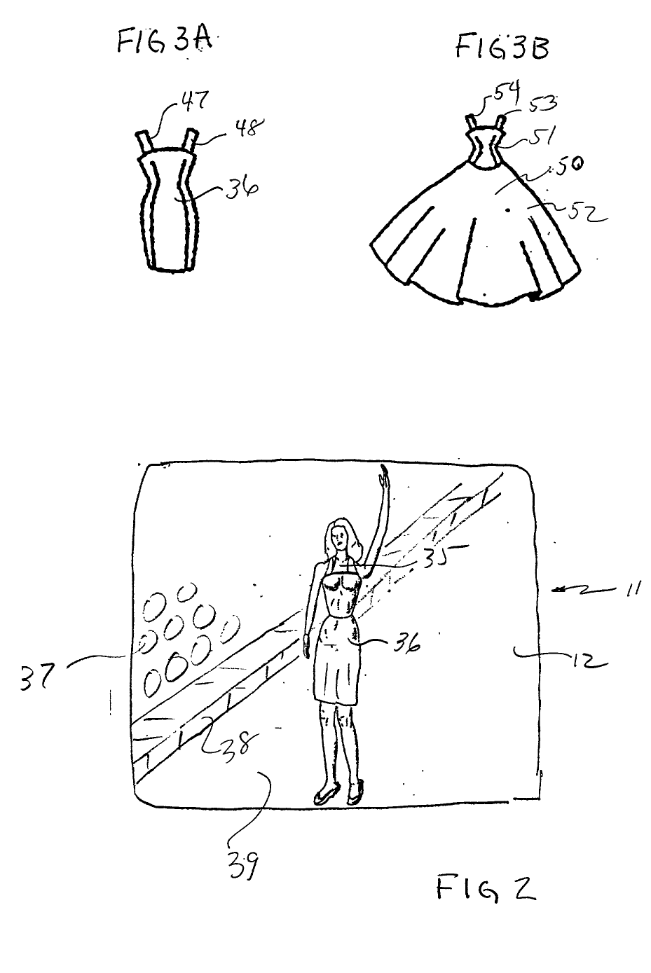

FIGS. 3A and 3B set forth front views of a pair of garments to provide examples of the present invention game play. FIG. 3A depicts a simple straight line dress 36 while FIG. 3B depicts a more formal full skirted gown 50. It will be apparent to those skilled in the art that dresses 36 and 50 are selected merely for illustration and that the present invention game is not limited to any particular style or fashion. It will be equally apparent to those skilled in the art that a wide variety of fashion items may be fabricated in accordance with the present invention such as capes, stoles, purses or the like without departing from the spirit and scope of the present invention and through use of the present invention game play.

More specifically, FIG. 3A sets forth a front view of dress 36 shown in FIG. 2 worn upon animated FIG. 35. Dress 36 is a simple straight line dress or “sheath” type dress having a pair of shoulder straps 47 and 48. The pattern from which dress 36 is fabricated is set forth below in FIG. 4 and the fabrication of dress 36 is described in conjunction with FIG. 4 in greater detail. Suffice it to note here that dress 36 is formed to be worn upon an otherwise conventional fashion doll of the type having articulated shoulders and legs which are usually formed from molded plastic components or the like.

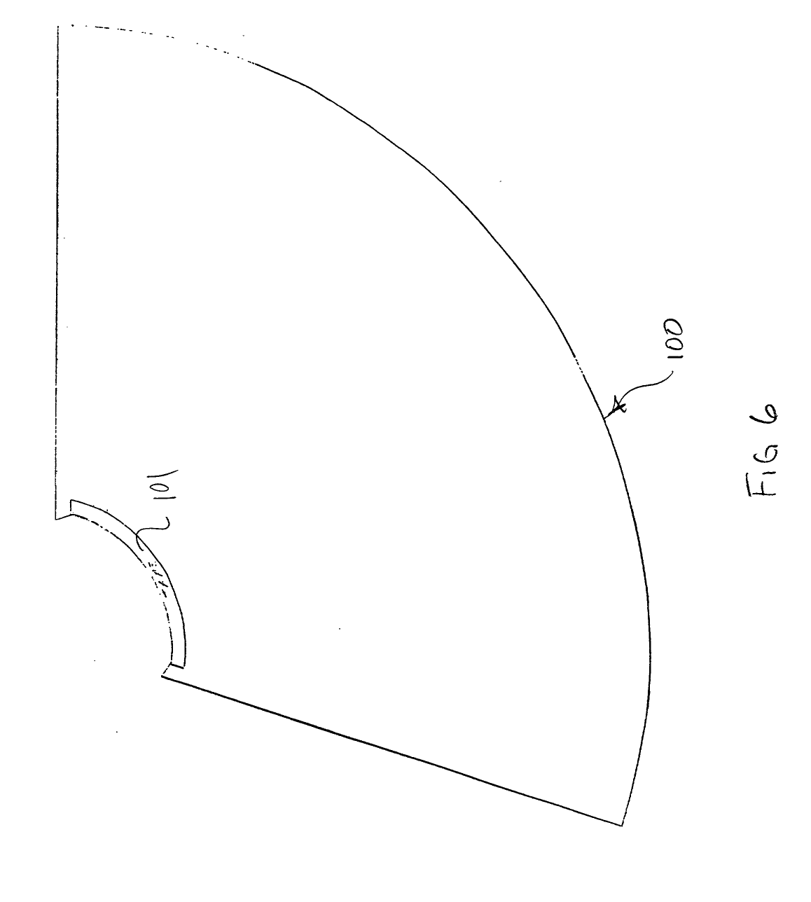

FIG. 3B sets forth a front view of an alternative fashion dress 50 having a bodice portion 51, a skirt portion 52 attached thereto and a pair of shoulder straps 53 and 54. The patterns required to fabricate dress 50 are set forth in FIGS. 5 through 7 below. Accordingly, the descriptive material which accompanies FIGS. 5 through 7 sets forth the assembly or fabrication of dress 50. Suffice it to note here, however, that dress 50 is sized in the same manner as dress 36 to be worn by a conventional fashion doll as an alternative ensemble for the doll. Thus, with reference to FIGS. 1, 2, 3A and 3B, it should be noted that the child user is, in accordance with the descriptive material set forth below in FIGS. 4 through 7, able to design a plurality of fashion items which are then printed in pattern form upon a fabric medium using a conventional printer. The fashion items are then cut from the printed medium and formed into the doll fashion items using attachment apparatus such as double-side adhesive tape or the like. Thus, in accordance with the present invention, the child user is able to exercise substantial creativity in designing a fashion item, examining the item in an animated figure display, selecting the colors and patterns for the fabric to be used, and thereafter printing a pattern from which the item may be fabricated. In further accordance with the present invention, it will be recognized that a virtually endless variety of fashion items may be formed using a plurality of stored patterns and combinations of patterns upon CD-ROM 29 (seen in FIG. 1).

FIG. 4 sets forth a printed pattern from which dress 36 may be fabricated. It will be apparent to those skilled in the art that pattern 60 is formed using the above-described design and printing process. Thus, pattern 60 includes a front panel 61, a side/rear panel 62 and a side/rear panel 63 commonly joined in the upper portion of pattern 60. In the anticipated fabrication of the present invention fashion game, pattern 60 is printed upon a printed pattern sheet such as sheet 42 shown in FIG. 1. Accordingly, pattern 60 is cut from the pattern sheet by the child user cutting along the outer edge of pattern 60. Once pattern 60 has been cut out, the fabric portion of dress 36 is peeled from backing material 36 starting at a convenient corner as shown in FIG. 4. Also shown in FIG. 4 is a pattern for the shoulder straps which is either formed from ribbon of convenient size or, alternatively, printed as shown and cut out in multiple replications to provide a pair of shoulder straps. Each of the cutout shoulder straps, such as shoulder straps 72 defines tape areas 73 and 74 at the end portions thereof to be utilized in receiving a correspondingly shaped segment of double-sided adhesive tape cut from roll 17 (seen in FIG. 1).

Once pattern 60 has been cut out, it should be noted that a plurality of tape areas 64, 65, 66 and 69 are designated about various portions of pattern 60 to indicate the regions of the pattern which are to receive double sided tape to facilitate assembly of dress 36. In addition, a pair of fabric attachment book pads 67 and 68 are attached as shown in FIG. 4 using conventional fabric adhesives. Correspondingly, a pair of loop fabric attachment pads 70 and 71 are attached to pattern 60 as indicated in FIG. 4.

With tape applied to the indicated tape areas and the hook and loop fabric attachment pads in place, the assembly or fabrication of dress 36 is completed by positioning each side/rear panel so as be attached to front panel 61 along tape areas 64 and 65 and thereafter folding side/rear panels 62 and 63 about the doll torso (not shown) to be joined at their edges along the rear portion of the dress to complete the fabrication of dress 36. Finally, a pair of straps such as straps 72 are attached to the bodice portion of dress 36.

It should be noted that for purposes of illustration, dress 36 is shown to have a plurality of generally horizontal stripes 77 printed thereon. In accordance with the present invention, a variety of patterns may be printed upon the dress fabric in the above-described printing process to complete the decoration of the dress.

FIG. 5 sets forth a bodice portion 80 printed in the above-described process which is used to form bodice portion 51 of doll dress 50 shown in FIG. 3B. Accordingly, bodice portion 80 includes a front panel 91 and a pair of side/rear panels 92 and 93. As described above, bodice portion 90 is formed in the above-described printing process utilizing a supporting backing sheet which is removed following the cut-out of bodice portion 80. As is also described above, bodice portion 80 includes a plurality of tape application areas 81, 82, 83, 84 and 87 to which elongated ribbons of double-sided adhesive tape having been cut from roll 17 shown in FIG. 1 are positioned. In addition, a plurality of hook and loop fasteners 85, 86, 87, 88 and 89 are secured to bodice portion 80 as shown. A pair of elongated shoulder strap portions such as shoulder strap 94 having end portions 95 and 96 are further cut to provide shoulder straps. In the preferred embodiment of the present invention, end portions 95 and 96 receive fabric attachment pads for attachment to bodice portion 80. Bodice portion 80 is folded to form a doll dress bodice in the similar manner to that described above for dress 36 joining front panel 91 to side/rear panels 92 and 93 and attaching a pair of shoulder straps such as shoulder strap 94 to attachment pads 87, 88 and 85.

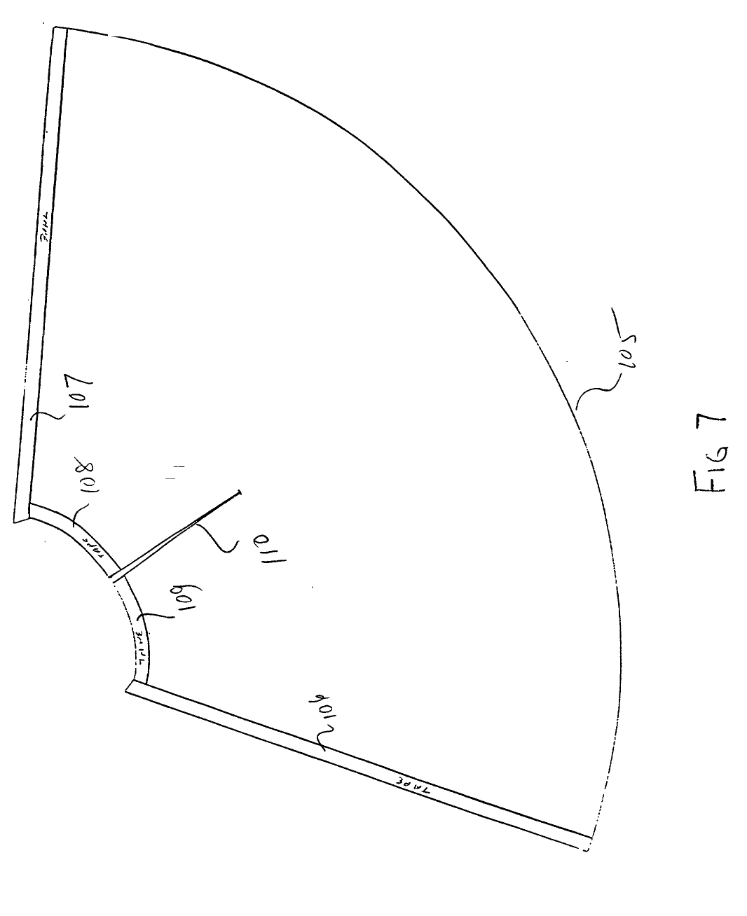

FIG. 6 sets forth a skirt front 100 cut from a printed pattern sheet such as sheet 42 shown in FIG. 1 used in fabricating dress 50 shown in FIG. 3B. A curved tape portion 101 is designated upon the upper portion of skirt front 100.

FIG. 7 sets forth a skirt back 105 which when combined with skirt front 100 forms the completed skirt for dress 50 (shown in FIG. 3B). Skirt front 105 is similar in shape to skirt front 100 and includes a pair of edge tape areas 106 and 107, a pair of waist tape areas 108 and 109 and a fitting slit 110.

With simultaneous reference to FIGS. 6 and 7, skirt front 100 and skirt back 105 are joined to bodice portion 80 (seen in FIG. 5) upon the doll (not shown) using double-sided adhesive tape on tape portions 101, 108 and 109 at the waist portion of bodice 80. The joining of skirt front 100 to skirt back 105 is completed by adhesive attachment using tape positioned along tape portions 106 and 107 to secure the respective edges of skirt front 100 to skirt front 105.

The result of the above-described fabrication is the attachment and assembly of dress 50 (seen in FIG. 3B) upon a host doll to complete the activity of the present invention fashion game.

What has been shown is a novel fashion game in which the child user is able to design a doll garment, vary the doll garment in color, pattern and design, select a designed doll garment from a plurality of components within the game and print a plurality of patterns used in forming a garment.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A method of playing a fashion game on a computer, said method comprising the steps of:
forming a display of a doll garment image;
observing said doll garment upon a doll image;
animating a doll image having said garment thereon;
printing a pattern corresponding to said garment upon a fabric sheet;
cutting said pattern from said sheet to form a cut-out;
forming said cut-out into a doll garment.
